(19) United States
(12) Patent Application Publication
(10) Pub. No.: US 2010/0139499 A1
(43) Pub. Date: Jun. 10, 2010

(54) Milk holder for a beverage making machine

(75) Inventor: Jens Martin Meuer, Duisburg (DE)

Correspondence Address: Oppedahl Patent Law Firm LLC (P&A), P O Box 5940, Dillon, CO, 80435-5940, US

(73) Assignee: WIK FAR EAST LTD., North Point (CN)

(21) Appl. No.: 12/632,527

(22) Filed: Dec. 7, 2009

(30) Foreign Application Priority Data
Dec. 6, 2008 (DE) 20 2008 016 202.5

(51) Int. Cl. A23C 3/04

(52) U.S. Cl. 99/455

(57) ABSTRACT

A beverage making machine, such as a coffee machine, has a thermally insulated milk holder 1 coordinated with the machine to hold a milk package 11. The milk holder 1 has a pipeline opening 5 to let through a milk pipeline reaching into the package 11 to tapping the milk. At least one compartment 12 to receive at least one passive cooling element 16 is arranged in a chilling space 10 of the milk holder 1 separately from a milk package 11. In the cooling element compartment 12, a cooling element 16 can be inserted and removed. The chilling space 10 to hold the milk package 11 is designed such that, in order to achieve a uniform chilling of the milk contained in the package 11, it can be placed within the chilling space 10 at a distance from the at least one cooling element compartment 12 and from at least one of the side walls bordering the chilling space 10, and the chilling space 10 to hold the package 11 containing milk is bounded at the bottom by a floor 14 for placing the package 11 thereupon and this floor 14 forms a placement surface that is larger than the standing surface of the package 11 placed thereon. The milk holder 1 can be used separate from the beverage making machine.

### BACKGROUND

The invention relates to beverage making machines, particularly coffee machines, with a thermally insulated milk holder connected to the machine to hold a milk package. The milk holder has a pipeline opening for a milk pipeline for the tapping of the milk package.

Coffee machines can have a milk holder, particularly so-called fully automatic ones. Such a milk holder, often an accessory for these coffee machines, serves to keep a supply of milk on hand for the making of coffee and milk mixed drinks, such as cappuccino or the like. Typically, such a milk holder is a container next to the coffee machine proper. The milk holder has a milk pipeline coming out of it connected to a suction pump in the coffee machine. Chilled milk holders are also known, in addition to milk holders where the milk is poured from its package. Such milk holders can have a thermally insulated housing or active refrigeration. Active refrigeration can use a Peltier element or the rather familiar compression principle. The milk remains in its packaging in these refrigerated milk holders. The milk pipeline is inserted into the package and extends from the housing through a pipeline opening. An electrical power supply is required in order to operate such a refrigerated milk holder. For such a milk holder, it is advantageous to be able to cool the milk package inserted therein down to the desired chilling temperature.

To an increasing degree, fully automatic coffee makers are also being used in the home. The purchase of an additional milk refrigerator is often seen as unnecessary, sometimes due to space and/or electricity consumption considerations. However, consumers want to be able prepare mixed coffee and milk beverages. To do this without a milk holder, one can either pour the milk into a holder or place the milk package next to the coffee machine. In these situations, however, the user often discovers that the milk has become sour and the mixed coffee and milk drink is ruined.

The foregoing example of the related art and limitations related therewith are intended to be illustrative and not exclusive. Other limitations of the related art will become apparent to those of skill in the art upon a reading of the specification and a study of the drawings.

### SUMMARY

One aspect of the present disclosure to provide a beverage making machine with a milk holder with at least one compartment to receive one or more passive cooling elements in a chilling area spaced apart from the milk package. The cooling element can be inserted and removed into the cooling element compartment as desired. The chilling area for the milk package is designed such that there is space around the milk package to achieve a uniform chilling of the milk contained in the package. The package can be placed within the chilling area spaced apart from the at least one cooling element compartment and the least one of the side walls bordering the chilling space. The chilling area for the milk package has a floor that the milk package is placed on that is larger than the standing surface of the package.

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

This beverage making machine has an insulated milk holder with passively cooled chilling space is by use of one or more cooling elements. The interior of the milk holder is divided into a chilling space and a cooling element compartment. The chilling space itself is designed to hold a milk package, wherein the volume of the chilling space is distinctly larger than the volume of the milk package to be placed therein. This serves the purpose that the milk package can be arranged at a distance from the at least one cooling element, as well as from at least one, but preferably all, side walls of the chilling space. This arrangement causes a thermal convection to be created inside the chilling space, bathing the milk package in the cold convention air. The convection is created by the cold of the cooling element used in the cooling compartment, typically a frozen cold pack. The placement surface of the chilling space can have stand heighteners that the milk package is placed on to allow a cooling air current all around the milk package. These stand heighteners can be ridges or truncated cone elevations, for example. This creates pathways for air to flow underneath the milk package due to the cooling convection. This helps ensure a uniform cooling of the milk in the package.

To use such a milk holder, a pre cooled milk package is placed in the chilling space while a cold pack taken from the freezer, where it has been cooled to below freezing temperatures, is placed in the cooling element compartment. The milk holder is typically closed by a lid at both top and bottom, so that the desired convection within the chilling space can be adjusted without the relatively warm ambient air getting into the milk holder. Such a milk holder can have a compact construction. In particular, it requires no electrical connections for a proper operation. The critical point is that the milk kept therein remains properly chilled for many hours, and in order to further maintain the desired cooling temperature it is only necessary to replace the first cooling element in the milk holder with one taken out of the freezer. The insulation of the cooling receptacle and the refrigerating capacity of such a cooling element are designed so that a proper cooling of a milk package placed in the chilling space is maintained for six to eight hours, or even longer, without having to replace the cooling element. Consequently, the milk in the package remains fresh and wholesome for the entire period of time the machine is in use in a day.

The compact and economical construction of this milk holder is made possible by the design and arrangement of the milk package in the chilling space. Due to the distance of the milk package from the inner walls to allow a cooling convection to form, an additional insulating layer is created by the air in the open space. Consequently, the thermal insulating layer of housing of the milk holder, which is typically a foam layer, can be less thick. This takes advantage of the fact that the number of heat transitions from the chilled milk contained in the package to the outside of the milk holder is increased. This has direct impact on a reduction in structural size, and in this context from a visual standpoint a reduction in structural size of a few millimeters can be decisive to the width and depth.

The cooling element compartment is separated from the actual chilling space for the milk package in such a way that the aforementioned cooling convection can be established in the chilling space. This means that the separation serves the purpose of distancing the cooling element or elements from the milk package. This separation can be achieved by an inwardly projecting rib of slight height molded onto the inside of the milk holder. It is provided that the opening between the chilling space and the cooling element compartment is slightly less than the dimensioning of the cooling element to be used in the cooling compartment in this respect. Finally, the rib serves to hold the cold pack in its cooling compartment.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a perspective schematic view of a milk holder associated with a coffee machine.

FIG. 2 is a longitudinal sectional view of the milk holder of FIG. 1.

FIG. 3 is a horizontal, cross sectional view of the milk holder of FIG. 1.

FIG. 4 is a section through the milk holder corresponding to FIG. 3, with a different milk package inserted therein.

FIG. 5 is an enlarged perspective partial view of the upper closure of an alternate embodiment of a thermally insulated milk holder.

FIG. 6 a cutout view of one side view of the milk holder of FIG. 5.

Before explaining the disclosed embodiment of the present invention in detail, it is to be understood that the invention is not limited in its application to the details of the particular arrangement shown, since the invention is capable of other embodiments.

Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

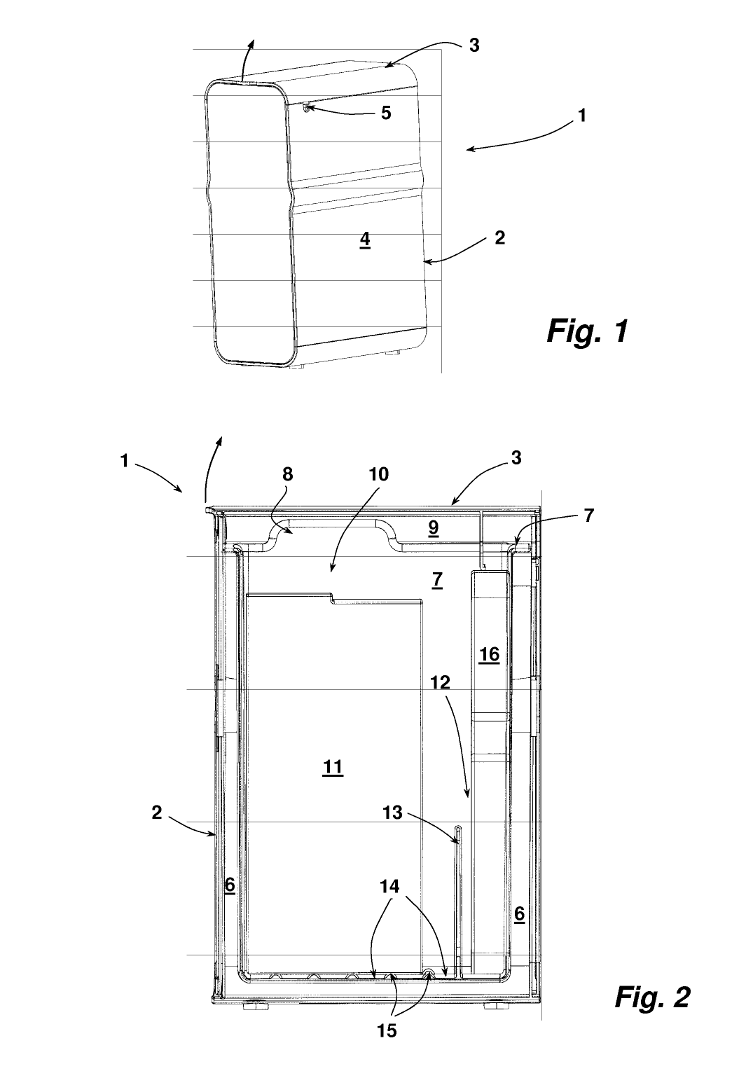

Referring first to FIG. 1, a milk holder 1 is associated in a way not further detailed with a coffee machine designed as a fully automatic unit. T he milk holder 1 has a plastic housing 2. Part of the housing 2 is a top lid 3, which is pivoted on the rest of the housing 2. The pivoting movement to open the lid 3 is indicated by an arrow A in FIGS. 1 and 2. In the upper closure of a side wall 4 of the housing 2 there is a U-shaped pipeline opening 5. The pipeline opening 5 is bounded at the top by the lower edge of the lid 3. The pipeline opening 5 serves to allows a milk tapping line to exit the milk holder 1. The pipeline is inserted into the milk package at one end and at its other end is connected to a suction pump of the beverage making machine. Milk can be tapped for the making of a milk or a mixed milk and coffee drink through the milk tapping line.

The milk holder 1 has, besides its housing 2 and a thermal insulating layer 6 applied to its inside, a plastic insert 7. The insert 7 can be taken out of the housing 2 when the lid is opened. For this purpose, the insert 7 has handle projections 8. The lid 3 is likewise insulated with a thermal insulating layer 9 as seen in FIG. 2.

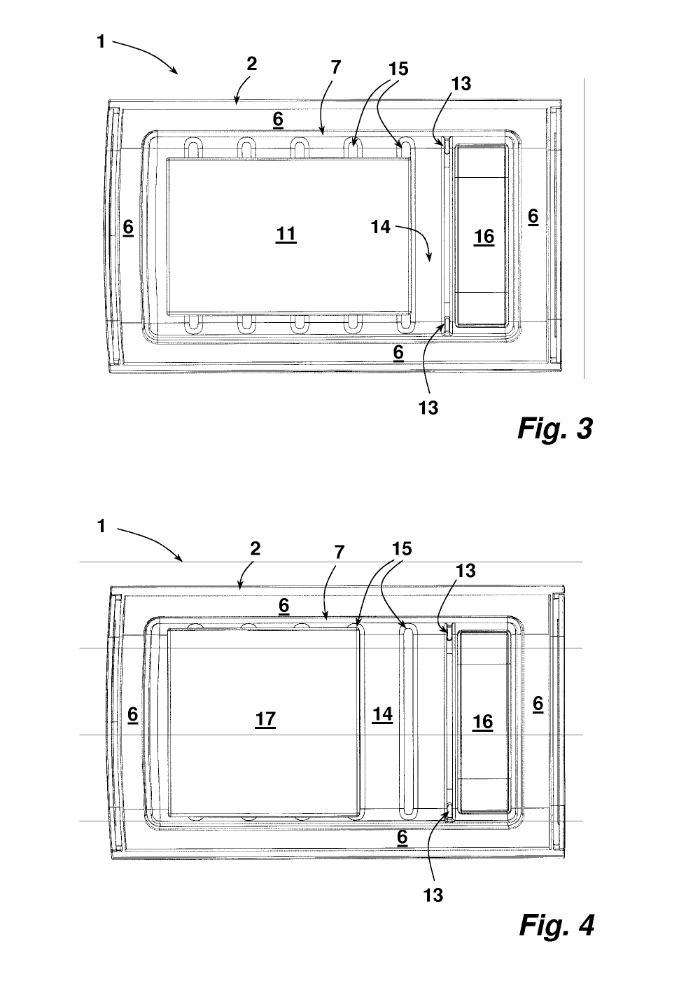

The insert 7 is divided into two spaces or regions. One region of the insert 7 forms a chilling space 10, in which a milk package 11 is inserted. The other region of the insert 7 is designed as a cooling element compartment 12. The two regions 10, 12 are separated by a rib 13 projecting from the inner wall of the insert 7 which, as is evident from FIG. 3, extends for only a small height into the interior of the insert 7 and is located only in the lower third of the insert 7. The floor 14 of the chilling space 10 of the insert 7 has several ridge-like stand heighteners 15 that the milk package 11 stands on top of As is evident from FIG. 3, the placement surface of the floor 14 of the chilling space 10 is larger than the standing surface of the milk package 11, so that the latter is at a distance from the side walls of the insert 7. The representation in FIG. 3 makes it clear that adequate air remains between the milk package 11 and the side walls of the insert 7. Likewise, the milk package 11 is distanced from a cooling element 16 inserted into the cooling compartment 12 thanks to the dimensioning of the chilling space 10. The dimensioning of the cooling element 16 in the direction of the height of the rib 13 is slightly greater than the clear width of the rib ends facing each other, by which the clear width of the opening between the chilling space 10 and the cooling element compartment 12 is determined. This guarantees that the cooling element 16 remains in the cooling compartment 12 even during movement of the milk holder. Due to the design of the space separation, a milk package 11 placed in the chilling space 10 should not come into direct contact with the cooling element 16. This should also be prevented so that milk contained inside the milk package 11 does not start to freeze in some areas if placed directly next to the cooling element 16, which is at freezing temperatures.

In the sample embodiment shown, the chilling space 10 of the milk holder 1 is designed so that different milk packages can be placed therein. Whereas FIGS. 2 and 3 show a milk package with rectangular standing surface, in FIG. 4 a milk package 17 with a square standing surface is inserted in the milk holder 1 or its insert 7. The milk package 17 is higher than the milk package 11.

Referring to FIGS. 2, 3 and 4, a cooling convection is established inside the chilling space 10 of the milk holder 11 when a cooling element 16 having a below-freezing temperature is placed in the cooling compartment 12, so that the milk already chilled in the package 11, 17 remains uniformly chilled. This is advantageous for the proper preparation of a milk or mixed coffee and milk beverage. The milk holder 1 is designed in terms of the thickness of its insulating layers 6, 9, the thermal conductivity of the plastics used to form the housing 2, the lid 3, and the insert 7, the dimension of the chilling space 10 and that of the cooling element 16 coordinated with the milk holder 1 that the milk contained in the milk package 11, 17 can be held for six to eight hours at sufficiently chilled temperature when the milk package is removed from the refrigerator and placed in the milk holder 1. Moreover, the milk holder can be relatively small in construction. In the sample embodiment shown, 1 liter of milk is contained in each of the milk packages 11, 17. The volume of the cooling element 16 in this sample embodiment is around 20 to 25% of the volume of a milk package 11, 17.

The milk holder 1 comes with another cooling element, not shown in the figures, which is identical to the cooling element 16 depicted. While the one cooling element 16 is placed in the milk holder 1, the other cooling element is placed in the freezer compartment of a refrigerator or freezer. The cooling elements 16 can then be used alternately for placement in the milk holder 1.

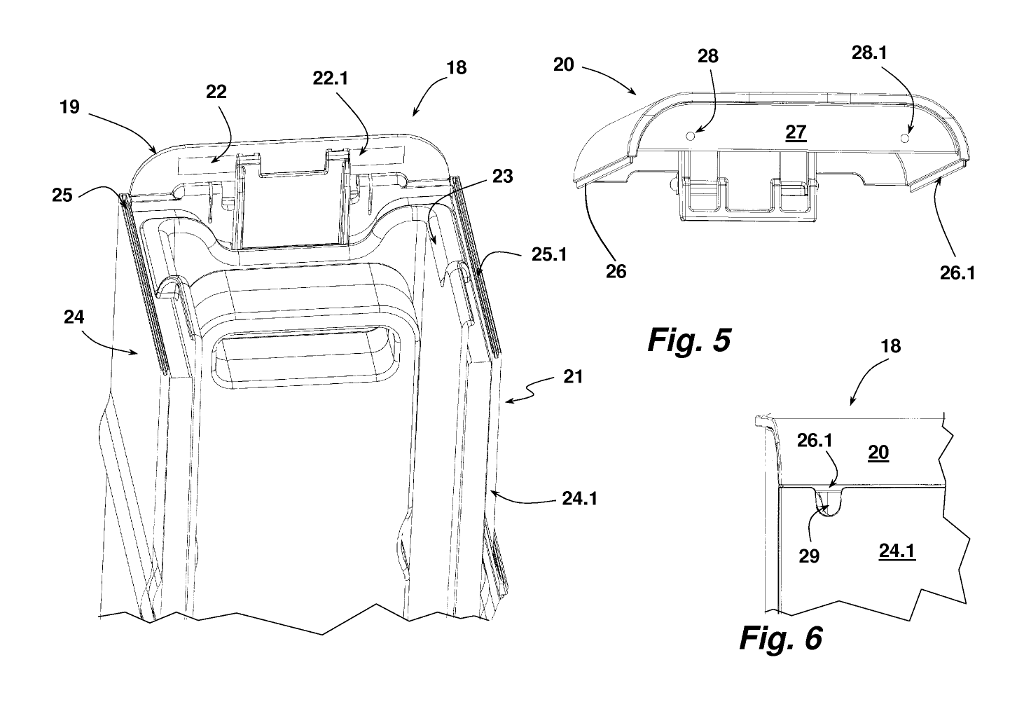

In FIG. 5, another milk holder is shown in a perspective cross sectional view. The milk holder 18 corresponds to the milk holder 1, but in contrast to the milk holder 1 it has a lid 20 hinged to its rear end face 19. The lid 20 in the representation of FIG. 6 has been removed from the housing 21 of the milk holder 18. The lid 20 can be fastened to the housing 21 by means of hinge parts which can be inserted into two rectangular openings 22, 22.1. The hinge parts are held in the openings 22, 22.1 during normal swivel movements of the lid. The locking is released if the lid 20 is swiveled open by more than its designed width. In this way, the lid 20 can easily be removed from the housing 21. This is required when the insert 23 needs to be taken out of the housing 21 for cleaning purposes, for example. The upper ends of the side walls 24, 24.1 of the housing 21 have a groove 25, 25.1 following the lengthwise dimension of the housing 21. Complementary to this, the lid 20 has ridges 26, 26.1 on its lengthwise sides for fitting into the respective groove 25 and 25.1 when the lid 20 closes the housing 21. This improves the thermal insulation of the inner space of the milk holder 18. This insulation of the milk holder 18—the same as for the milk holder 1 of FIGS. 1 to 4—also has the result that almost no air exchange occurs between the surroundings of the milk holder and the interior. This helps prevent moisture from getting into the interior of the milk holder 18, which might condense inside the milk holder 18.

The lid 20 engages the openings 22, 22.1 by its hinges and has two detent bumps 28, 28.1 on the front end face 27 in FIG. 5. These engage with detent depressions arranged on the inside of the front end face of the housing 21 (not shown) in the closed position of the lid.

The pipeline opening 29 can be seen in the magnified side view of FIG. 6, through which a milk pipeline is led out from inside the milk holder 18. The pipeline opening 29 is in the shape of a trough or U in the depicted embodiment. This U-shaped recess is made in the side wall 24.1 of the housing 21 in the region of its upper end. The pipeline opening 29 is closed on top by the ridge 26.1 of the lid 20 when the lid 20 is closed, as seen in the drawing of FIG. 6. Depending on the diameter of the milk pipeline inserted in the pipeline opening, the pipeline can be fixed in the opening 29 by the ridge 26.1. The U-shaped design of the pipeline opening 29 means that the pipeline opening 29 is not completely filled by a circular milk pipeline. The spandrels remaining after a milk pipeline is inserted in the pipeline opening 29 allow surrounding air to flow into the milk holder 18 when milk is tapped so that the milk can be emptied from the package in the milk holder 18 under constant pressure conditions.

In the depicted embodiment, the insulation used is foam with a density of 80 g per liter, which is a relatively hard foam. The stress-strain compression per ISO 3386 is 170 for the foam used. This type of foam was used because it has been found to be especially suitable for purposes of the aforementioned insulation and furthermore it guarantees that the insert can be easily pulled out from the insulation and then shoved back into the housing with the insulation when an insert is provided inside the housing.

The description of the beverage making machine with its coordinated milk holder makes it clear that such a milk holder can also be used basically for the cooling of other liquids that are to be processed by a beverage making machine, especially a hot beverage making machine. Therefore, the disclosure content of these documents is not limited to the application as a milk holder. Likewise, several pre-chilled milk packages can also be arranged in such a milk chilling receptacle.

It is also possible to use such a chilling receptacle independently of a beverage making machine, especially a coffee machine.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true sprit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The above definitions are provided to clarify their specific use in the context of the invention.

List of reference symbols
1 milk holder
2 housing
3 lid
4 side wall
5 pipeline opening
6 insulating layer
7 insert
8 handle projection
9 insulating layer
10 chilling space
11 milk package
12 cooling element compartment
13 rib
14 floor
15 stand heightener
16 cooling element
17 milk package
18 milk holder
19 rear wall
20 lid
21 housing
22, 22.1 opening
23 insert
24, 24.1 side wall
25, 25.1 groove
26, 26.1 web
27 end face
28, 28.1 detent bump
29 pipeline opening

I CLAIM:

1. A thermally insulated milk holder for a beverage making machine for holding a milk package with a pipeline opening to let through a milk pipeline reaching into the package for tapping of the milk, the insulated milk holder comprising:
at least one cooling element compartment to receive at least one passive cooling element, said passive cooling element can be inserted and removed in said cooling element compartment;
a chilling space to hold a milk package,
the passive cooling element is arranged in the chilling space of the milk holder separately from the milk package;
the chilling space to hold the milk package is designed such that the milk package can be placed within the chilling space at a distance from the at least one cooling element compartment and at a distance from at least one of a side walls of the chilling space; and
the chilling space bounded at the bottom by a floor for placing the package thereupon, the floor forming a placement surface that is larger than a standing surface of the milk package placed thereon in order to achieve a uniform chilling of the milk contained in the package

2. The device according to claim 1, wherein the placement surface of the chilling space has stand heighteners on which the milk package introduced into the chilling space stands.

3. The device according to claim 1 or 2, wherein at least one cooling element compartment is separated by a rib projecting from the side walls into the interior of the milk holder.

4. The device according to claim 3, wherein the separation formed by the rib leaves a free space between the chilling space and the cooling element compartment whose clear width is only slightly smaller than the extension of a cooling element to be placed into the cooling element compartment in the direction of the height of the rib.

5. The device according to claim 1 or 2, wherein the milk holder further comprises a housing, a thermal insulating layer applied to the inner surface of the housing and an insert forming the chilling space with the at least one cooling element compartment, said insert can be removed from the housing with thermal insulation.

6. The device according to claim 5, further comprising a lid pivotally mounted on the housing to close the chilling space formed by the insert.

7. The device according to claim 6, wherein the lid completely closes the top side of the housing.

8. The device according to claim 1 or 2, wherein the pipeline opening is formed in an upper edge of the housing, in order to let through the milk pipeline.
